(19) United States
(12) Patent Application Publication
(10) Pub. No.: US 2016/0295942 A1
(43) Pub. Date: Oct. 13, 2016

(54) LAMINATED TEXTILE

(71) Applicant: COVEC LIMITED, Surrey (GB)

(72) Inventor: Keith BLOXSOME, Surrey (GB)

(21) Appl. No.: 14/783,777

(22) PCT Filed: Apr. 22, 2014
(86) PCT No.: PCT/GB2014/051246

§ 371 Date: Oct. 9, 2015

(30) Foreign Application Priority Data
Apr. 19, 2013 (GB) 1307104.8

(51) Int. Cl. A41D 31/00; D06M 17/00; B32B 7/12; B32B 5/26; B32B 5/02

(52) U.S. Cl. CPC A41D 31/0061; B32B 5/26; B32B 5/024; B32B 5/026; B32B 7/12; D06M 17/00; B32B 2262/0276; B32B 2437/00

(57) ABSTRACT

There is provided a drapable textile material comprising a base layer of a first knitted or woven textile material, a stabilising layer of a second knitted or woven textile material, and a bonding agent intermediate of the base layer and the stabilising layer that bonds the base layer to the stabilising layer, wherein the first knitted or woven textile comprises a liquid crystal polymer fibre and the second knitted or woven textile material consists of fibres that differ from the liquid crystal polymer fibre.

The present invention relates to the field of textiles. In particular, the present invention relates to improvements in the field of technical textiles and to technical textiles that can be used in the manufacture of clothing.

### BACKGROUND

Technical textiles are a growing sector of the textile industry. Function is normally the primary criterion for a technical textile. Technical textiles include textiles for automotive applications, medical textiles, geotextiles, agrotextiles, and protective clothing. When incorporated into clothing, the use of a technical textile can provide the end user with a clothing item that offers a number of functional advantages such as abrasion resistance, cut resistance, heat resistance, fire resistance, water resistance and/or burst resistance and the like. Some specific examples include heat and radiation protection for fire fighter clothing, molten metal protection for welders, stab protection, bulletproof vests and spacesuits.

Lyotropic aromatic polyamide fibre, commonly referred to as aramid fibre, has been used in protective apparel. For a lyotropic liquid crystal polymer (LLCP), the liquid crystallinity occurs by dissolving a polymer in a solvent. One well-known lyotropic aromatic polyamide fibre, commercially available under the trade name Kevlar®, is produced by the reaction of terephthalic acid and 1,4-phenylenediamine. While protective articles made with LLCP fibres can exhibit desirable properties, such structures, for example, can exhibit poor cut-resistance and can suffer from hydrolysis and high wear rates through low yarn-to-yarn abrasion resistance and low flex resistance, and hence poor protection for the end user.

Vectran® is a high-performance fibre spun from a thermotropic liquid crystal polymer (TLCP), wherein, for a thermotropic liquid crystal polymer, liquid crystallinity occurs by heating a polymer above its glass or melting transition point. It is believed to be the only commercially available melt spun liquid crystal polymer fibre in the world.

Vectran® has several key performance characteristics that make it more suitable for use in personal protective equipment (PPE), sports and leisure protection than LLCPs such as Kevlar® or high-modulus polyethylenes (HMPE), such as Dyneema®. Unlike LLCPs such as Kevlar®, Vectran® suffers from only minimal degradation due to moisture ingress (0.001 moisture absorption), and exhibits high yarn-to-yarn abrasion resistance and high flex resistance, and thereby provides prolonged continuous performance. Vectran® also has low thermal conductivity, and can therefore prevent friction heat transfer and provide a natural two-way thermal barrier, which provides benefits in both hot and cold climatic conditions. In comparison, high-modulus polyethylenes, such as Dyneema®, have high thermal conductivity. Vectran® offers a natural higher cut, burst and abrasion resistance then LLCPs, which increases its potential uses in PPE, sports and leisure protection.

Overall, Vectran® fibre exhibits exceptional abrasion resistance, cut resistance and moisture resistance. It has a very low creep, a high melting point and is around five times stronger than steel and ten times stronger than aluminium. It would therefore be desirable to be able to incorporate Vectran® into a technical textile. However, Vectran® is known to be unsuitable for high volume weaving, knitting, and cutting, due to its stiff, harsh and slippery properties. These properties make it not suitable for use in clothing.

In this regard, Vectran® is available in both filament and spun yarns. However, the cost of the Vectran® spun yarns is prohibitive, making them unfeasible for use in clothing, whilst Vectran® filament yarns are not suitable for cutting, as they present fraying and splitting problems due to the strong and slippery filament. In particular, cutting Vectran® filament yarns to an intricate pattern, such as those required to manufacture clothing, has proved to be especially problematic. To date, the only effective cutting method requires the use of lasers, which is time consuming and therefore restricts the volume that can be manufactured.

It is therefore desirable to provide a technical textile offering the features and advantages associated with the use of liquid crystal polymer-based yarns, particularly for use in the manufacture of clothing, that overcome the problems associated with effectively cutting such textiles.

### SUMMARY

According to a first aspect there is provided a drapable textile material comprising a base layer of a first knitted or woven textile material, a stabilising layer of a second knitted or woven textile material, and a bonding agent intermediate of the base layer and the stabilising layer that bonds the base layer to the stabilising layer, wherein the first knitted or woven textile comprises a liquid crystal polymer fibre and the second knitted or woven textile material consists of fibres that differ from the liquid crystal polymer fibre.

The bonding agent may bond a surface of the stabilising layer to an opposing surface of the base layer. Preferably, the bonding agent only partially penetrates both the stabilising layer and the base layer. More preferably, bonding agent only penetrates the stabilising layer so far as to bond with fibres that are present within the surface of the stabilising layer, and only penetrates the base layer so far as to bond with fibres that are present within the opposing surface of the base layer.

The liquid crystal polymer fibre may be a melt-spun liquid crystal polymer fibre. The liquid crystal polymer fibre may be a thermotropic liquid crystal polymer fibre. The second knitted or woven textile material may then consist of one or more fibres that are not thermotropic liquid crystal polymer fibres.

The liquid crystal polymer fibre can comprise monomer repeat units derived from 4-hydroxybenzoic acid and 6-hydroxy-2-naphthoic acid. Preferably, the liquid crystal polymer fibre comprises a Vectran® fibre or a derivative thereof. The liquid crystal polymer fibre may comprise Vectran® HTME 1670/600 T801M fibre or a derivative thereof.

The bonding agent may cover at least 50% of a surface of the stabilising layer and an opposing surface of the base layer. Preferably, the bonding agent is a substantially flexible adhesive. The adhesive may have a flexural modulus of between 1.450 psi (9.99 MPa) and 580,000 psi (3,998.96 MPa), and preferably between 6,000 to 7,000 psi (41.37 to 48.26 MPa).

The second knitted or woven textile material may consist of cotton or polyester or derivative thereof. The second knitted or woven textile material may be a woven fabric consisting of one or more of cotton and polyester.

According to a second aspect of the present invention there is provided a method of manufacturing a drapable textile material. The method comprises bonding a base layer of a first knitted or woven textile material to a stabilising layer of a second knitted or woven textile material using a bonding agent that is disposed intermediate of the base layer and the stabilising layer, wherein the first knitted or woven textile comprises a liquid crystal polymer fibre and the second knitted or woven textile material consists of fibres that differ from the liquid crystal polymer fibre.

The method may further comprise constructing the base layer of the first knitted or woven textile material from a liquid crystal polymer fibre-based yarn using a knitting machine.

The bonding of the base layer to the stabilising layer using a bonding agent may comprise applying the bonding agent so as to bond a surface of the stabilising layer to an opposing surface of the base layer. Preferably, the bonding agent is applied so as to only partially penetrate both the stabilising layer and the base layer. More preferably, the bonding agent is applied so as to only penetrate the stabilising layer so far as to bond with fibres that are present within the surface of the stabilising layer, and so as to only penetrate the base layer so far as to bond with fibres that are present within the opposing surface of the base layer.

There is also provided an item of clothing comprising the textile material according to the first aspect. In addition, there is also provided a textile material obtained or obtainable by the method of the second aspect, and an item of clothing comprising the textile material obtained or obtainable by the method of the second aspect,

### DETAILED DESCRIPTION

The technical terms and expressions used within the scope of this application are generally to be given the meaning commonly applied to them in the art. The word “comprising” does not exclude other elements or steps, and the indefinite article “a” or “an” does not exclude a plurality. A single step may fulfil the functions of several features recited in the claims. The terms “about”, “essentially” and “approximately” in the context of a given numerate value or range refers to a value or range that is within 20%, within 10%, or within 5%, 4%, 3%, 2% or 1% of the given value or range.

The description of this invention is written with respect to fibres and textile materials. The term “fibre” includes not only conventional single fibres and filaments, but also yarns made from a multiplicity of these fibres. In general, yarns are utilised in the manufacture of apparel, textile materials, fabrics, clothing and the like. Spun yarns are made from short, staple fibres that are twisted in order to hold the fibres together to form a yarn that is longer than the length of the individual fibres. Filament yarns are made from long, continuous fibres that are twisted together to form a yarn that has greater thickness and/or strength than an individual fibre. In general, textile materials are utilised in the manufacture of apparel, clothing and the like.

There will now be described an improved drapable textile material that offers the features and advantages associated with the use of liquid crystal polymer-based yarns, particularly for use in the manufacture of clothing, and that overcome the problems associated with effectively cutting such textiles. In this regard, a drapable textile material is a material that is sufficiently supple/flexible so as to hang loosely under its own weight, such that it conforms to complex or highly curved surfaces. In particular, the drapeability of the textile material provides that it is suitable for a broad range of clothing applications.

The improved drapable textile material comprises a base layer of a first knitted or woven textile material, a stabilising layer of a second knitted or woven textile material, and a bonding agent intermediate of the base layer and the stabilising layer that bonds the base layer to the stabilising layer. The first knitted or woven textile comprises a liquid crystal polymer fibre and the second knitted or woven textile material consists of fibres that differ from the liquid crystal polymer fibre. The base layer and the stabilising layer are each formed of knitted or woven textile materials. In contrast, non-woven fabric materials are made from fibres that are bonded together by chemical, mechanical, heat or solvent treatment, and the term “non-woven” is used in the textile manufacturing industry to denote fabrics, such as felt, which are neither woven nor knitted. Nonwoven materials typically lack strength and can have poor drapeability when compared with knitted and woven materials.

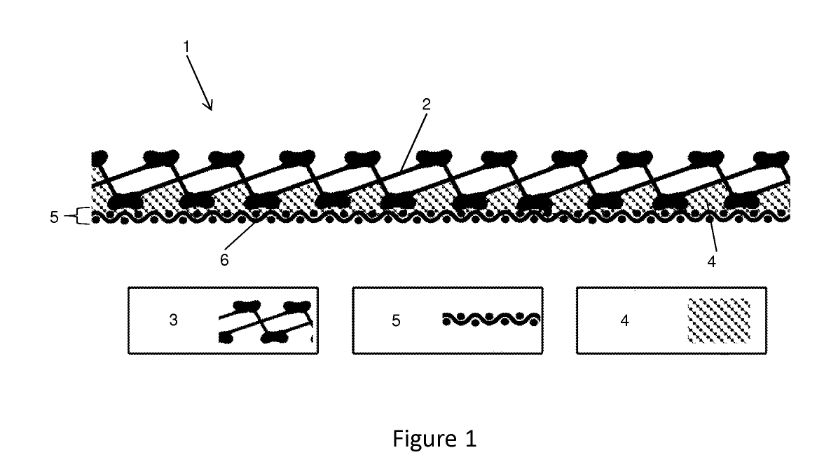

Referring now to FIG. 1, there is illustrated an embodiment of the drapable textile material 1 that makes use of a liquid crystal polymer fibre-based yarn 2 and that overcomes the problems associated with effectively cutting such materials. In the embodiment illustrated in FIG. 1, the drapable textile material 1 comprises a base layer 3 of a liquid crystal polymer fibre-based textile material 2 formed by knitting a liquid crystal polymer fibre-based yarn. A bonding agent 4 is then used to bond a surface of a stabilising layer 5 of a further textile material 6 to an opposing surface of the liquid crystal polymer fibre-based textile material 2, the further textile material consisting of fibres that differ from the liquid crystal polymer fibre, thereby forming a laminated textile material 1. As can be seen in FIG. 1, the bonding agent 4 only partially penetrates both the stabilising layer 5 and the base layer 3. In particular, the bonding agent 4 only penetrates the stabilising layer 5 so far as to bond with fibres that are present within the surface of the stabilising layer 5, and only penetrates the base layer 3 so far as to bond with fibres that are present within the opposing surface of the base layer 3.

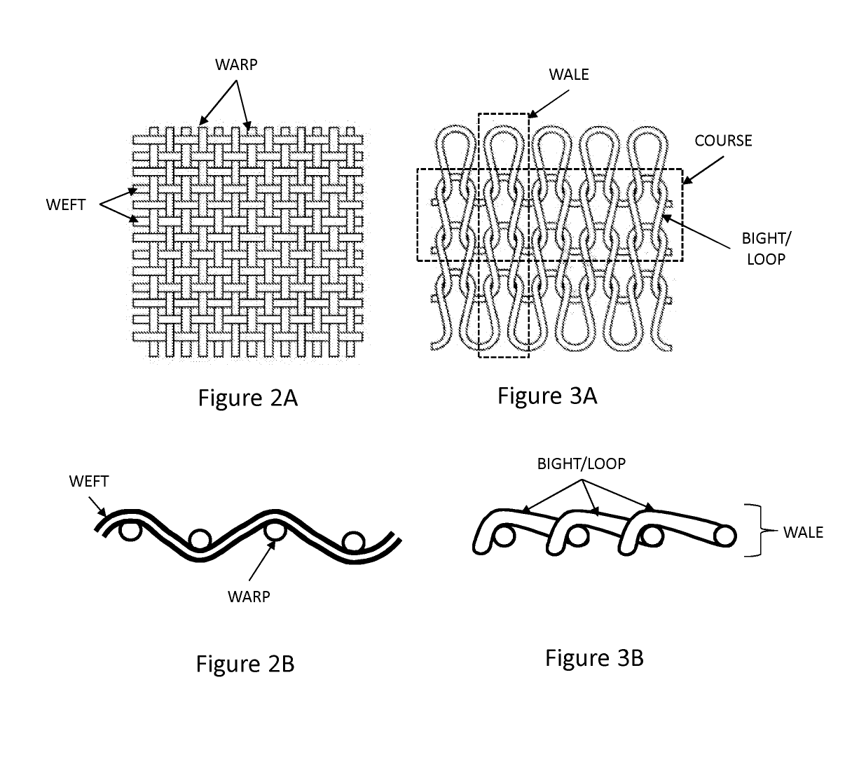

To further illustrate the bonding used to form the drapable textile material described herein, FIGS. 2A and 2B illustrate schematically examples of the structure of a woven textile material, whilst FIGS. 3A and 3B illustrate schematically examples of the structure of a knitted material. In particular, FIG. 2A illustrates the structure of an example of a woven textile material, whilst FIG. 2B is a cross-section through such a woven textile material illustrating the distribution of fibres throughout the depth of the material. FIG. 3A then illustrates the structure of an example of a knitted textile material, whilst FIG. 3B is a cross-section through such a knitted textile material illustrating the distribution of fibres throughout the depth of the material. It is noted that FIGS. 2A, 2B, 3A, and 3B, only illustrate examples of woven and knitted materials, and that woven and knitted materials can be formed using alternative types of weave and knit.

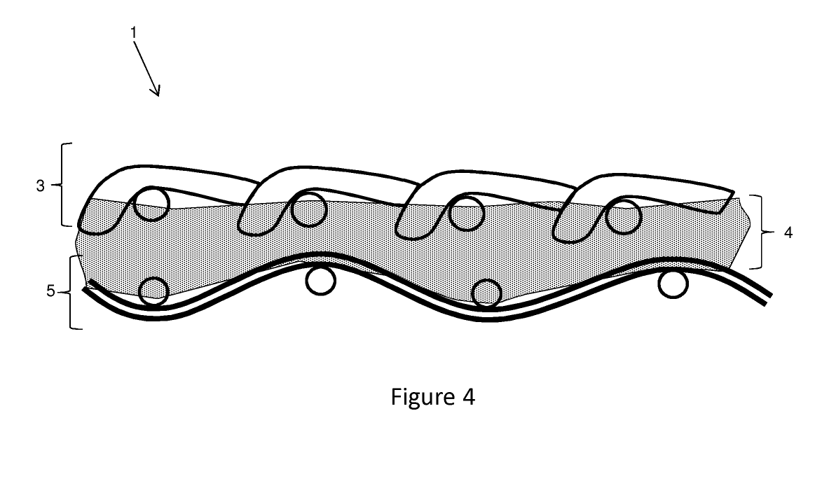

FIG. 4 then illustrates a cross-section through a drapable textile material 1 in which a stabilising layer 5 is provided by a woven textile material having the structure illustrated in FIG. 2B, and the stabilising layer 5 is bonded to a base layer 3 of a knitted material having the structure illustrated in FIG. 3B by a bonding agent 4. As can be seen in FIG. 4, the bonding agent 4 only penetrates the stabilising layer 5 so far as to bond with fibres that are present within the surface of the stabilising layer 5 that faces the base layer 3, and only penetrates the base layer 3 so far as to bond with fibres that are present within the opposing surface of the base layer 3.

The bonding of a layer of a further textile material to a liquid crystal polymer-based textile material stabilises the liquid crystal polymer-based textile material, and allows the resulting laminated textile material to be cut using conventional cutting techniques with high levels of accuracy. Among other reasons, the further textile material prevents the liquid crystal polymer-based textile material from slipping away from conventional cutting tools, as the further textile material consists of one or more further fibres (i.e. fibres that are different to the liquid crystal polymer fibre of the liquid crystal polymer fibre-based textile material) that have a different slip resistance/coefficient of friction to that of the liquid crystal polymer fibre.

Furthermore, ensuring that the bonding agent only partially penetrates both the stabilising layer and the base layer of the laminated textile material leaves a large proportion of the fibres present in the both the stabilising layer and the base layer free of the bonding agent, and minimises the amount of bonding agent required, thereby optimising the flexibility/drapeability of the laminated textile material whilst also providing that the two layers are sufficiently anchored to one another so as to move together.

When preparing to bond a surface of the stabilising layer 5 of further textile material to an opposing surface of the base layer 3 of liquid crystal polymer-based textile material, the bonding agent 4 can be applied to either a surface of the stabilising layer of further textile material or a surface of the base layer 3 of liquid crystal polymer-based textile material. Alternatively, the bonding agent 4 can be applied to both a surface of the stabilising layer 5 of further textile material and a surface of the base layer 4 of liquid crystal polymer-based textile material.

Preferably, the bonding agent is a substantially flexible adhesive. For example, such a substantially flexible adhesive could be provided by a bonding resin that is substantially flexible when cured. In this regard, a suitably flexible adhesive has minimum a flexural modulus of approximately 1.450 psi (9.99 MPa), which is the lower flexural modulus of rubber, and a maximum flexural modulus of or around 580,000 psi (3,998.96 MPa), the higher flexural modulus of nylon. Preferably the flexible adhesive has a flexural modulus of between 6,000 to 7,000 psi (41.37 to 48.26 MPa), which is the average flexural modulus of rubber. One such suitable resin/adhesive material with a flexural modulus in the preferred bracket is a cis-1,4-polyisoprene (latex).

Other resins/adhesive materials that could be used are elastomer-based adhesives such as neoprene, polyacrylonitrile, polyurethane, styrene-butadiene solvent or emulsion type adhesives and styreny-isoprene-styrene, styrene-butadiene-styrene, styrene-ethylene, and butadiene-styrene thermoplastic adhesives. However, many other adhesives that maintain a suitable degree of flexibility upon curing are also usable. In this regard, the adhesive chosen must be suitably flexible for the particular application for which the textile material will be used. For example, if it is intended that the resulting textile material is used for motorcycle jeans, then the flexibility should be approximately equivalent to that of a denim so as to have a similar feel and level of drapeability.

It is also noted that the thickness of the bonding agent used to bond the base layer to the stabilising layer can impact upon the flexibility of the laminated textile material. In particular, for most bonding agents, the thicker the layer of bonding agent used, the lower the flexibility of the final laminated textile material. It is therefore preferably that the layer of bonding agent is thin relative to the thickness of one or both of the stabilising layer and the base layer. In particular, it is preferable that the layer of bonding agent is less than 2 mm thick.

Preferably, at least 50% of the surface of one of both of the base layer and stabilising layer should be covered with the bonding agent 4. The amount of bonding agent used is therefore substantially more than would be used for spot bonding or for chemical quilting the fabric layers together. In this regard, if less than 100% of the surface of one or both of the base layer and stabilising layer is covered with bonding agent, then the bonding agent should be distributed over the entire area of the surface so as to provide a discrete uniform distribution. In other words, if less than 100% of the surface of one or both of the base layer and stabilising layer is covered with bonding agent, then areas of the surface(s) covered by the bonding agent should form a regular pattern, so as to provide a generally uniform distribution of the bonding agent, and thereby ensure that any substantial movement of the stabilising layer relative to the base layer is prevented. In this regard, covering the entirety of the surface(s) of one of both of the base layer and stabilising layer with bonding agent maximises the extent to which the two layers are bonded to one another, and therefore maximises the extent to the stabilising layer anchors the base layer. However, distributing a pattern of the bonding agent over less than 100% but more than 50% of the surface(s) minimises the amount of bonding agent required, whilst still ensuring that the stabilising layer anchors the base layer sufficiently for effective cutting of the resulting laminated textile material. Furthermore, minimising the amount of bonding agent required optimises the flexibility/drapeability of the laminated textile material.

In the illustrated embodiments, the base layer 3 of liquid crystal polymer-based textile material has been constructed from liquid crystal polymer-based yarn using a knitting machine. In this regard, the liquid crystal polymer can be machine knitted using a rib or single stitch structure in a circular knitting machine. The resulting knitted liquid crystal polymer-based textile material is lightweight and maintains the qualities of the liquid crystal polymer fibre.

The liquid crystal polymer-based textile material can comprise a thermotropic liquid crystal polymer (TLCP) yarn. For example, thermotropic liquid crystal polymers can include aromatic polyesters, aliphatic-aromatic polyesters, aromatic polyesteramides, aliphatic-aromatic polyesteramides, aromatic polyesterimides and aromatic polyestercarbonates. The TLCPs can be aromatic polyesters and/or polyesteramides which form liquid crystalline melt phases at temperatures of less than about 360 C.° and optionally include one or more monomer units derived from terephthalic acid, isophthalic acid, 1,4-hydroquinone, resorcinol, 4,4′-dihydroxybiphenyl, 4,4′-biphenyldicarboxylic acid, 4-hydroxybenzoic acid, 6-hydroxy-2-naphthoic acid, 2,6-naphthalenedicarboxylic acid, 2,6dihydroxynaphthalene, 4-aminophenol, and 4-aminobenzoic acid. Some of the aromatic groups may include substituents which do not react under the conditions of the polymerization, such as lower alkyl groups having 1 to 4 carbons and/or aromatic groups.

Preferably, the liquid crystalline polyester comprises a melt-spun liquid crystal polymer fibre. More preferably, the liquid crystalline polyester comprises monomer repeat units derived from 4-hydroxybenzoic acid and 6-hydroxy-2-naphthoic acid, as taught in U.S. Pat. No. 4,161,470. Suitably, monomer units derived from 4-hydroxybenzoic acid comprise about 15% to about 85% of the polymer on a mole basis, and monomer units derived from 6-hydroxy-2naphthoic acid comprise about 85% to about 15% of the polymer on a mole basis. More suitably, the polymer comprises about 73% monomer units derived from 4-hydroxybenzoic acid and about 27% monomer units derived from 6-hydroxy-2-naphthoic acid, on a mole basis. This polymer is available in fibre form under the Vectran® trade mark from Kuraray Co. Ltd., Japan.

Various types of Vectran® are available, including Vectran® HT, Vectran® NT, and Vectran® UM. The liquid crystal polymer-based textile material can therefore comprise any of Vectran® HT, Vectran® NT and Vectran® UM, or a combination thereof. Vectran® HT (high tenacity) fibre offers benefits for applications requiring high strength, vibration damping, low moisture absorption, and low CTE. Vectran® NT (medium tenacity) fibre is a high modulus thermoplastic matrix fibre for applications requiring high impermeability, excellent property retention over a broad temperature range, and low moisture absorption. Vectran® UM (high elasticity/modulus) offers the highest modulus without sacrificing tensile strength. The basic physical properties comprise of a high tensile strength, high modulus, high cut and high abrasion resistance. The Vectran® can be filament or spun. The Vectran® can be extruded in to multiple denier. In particular, liquid crystal polymer-based textile material can comprise Vectran® 1670 denier, 600 filament yarn can be used.

The further textile material can consist of one or more further fibres that have a greater slip resistance and/or a lower cut resistance than the liquid crystal polymer of the liquid crystal polymer-based textile material. Typically, the further textile material will consist of one or more non-[thermotropic liquid crystal polymer] fibres (i.e. non-TLCP fibres). In other words, the further textile material can be comprised of one or more fibres that are not thermotropic liquid crystal polymer fibres. By way of example, the further textile material could comprise one or more natural fibres, such as cotton, alpaca, cashmere, catgut, llama, silk, wool, bamboo, cotton, flax, linen, hemp and the like and derivatives thereof. Alternatively, or in addition, the further textile material could comprise one or more synthetic non-TLCP fibres, such as nylon, modacrylic, olefin, acrylic, polyester, carbon fibre, Kevlar® and the like and derivatives thereof. In certain embodiments, the further textile material is preferably woven from cotton or polyester.

The following examples illustrate embodiments of laminated textile materials that make use of a liquid crystal polymer-based yarn and that overcome the problems associated with effectively cutting such materials. In this regard, these examples relate to various laminated textile materials that were manufactured using different knit stitches, adhesives and natural and/or synthetic fibre textile materials

### Example 1

With a circular knitting machine a 400 gsm 100% Vectran® HTME 1670/600 T801M rib stitched textile material was created that was bonded using cis-1,4-polyisoprene to a woven cotton textile material.

The laminated textile material was found to retain many of the features of Vectran® whilst increasing the flexibility of its uses, including, but not limited to, the use as a protective layer in motorcycle jeans that could pass the BS EN 13595-1 Level 1 standard.

### Example 2

With a circular knitting machine an 800 gsm 100% Vectran® HTME 1670/600 T801M single stitched textile material was created that was bonded using cis-1,4-polyisoprene to a woven cotton textile material.

The laminated textile material was found to retain many of the features of Vectran® whilst increasing the flexibility of its uses, including, but not limited to, the use as a protective layer in motorcycle jeans that could pass the BS EN 13595-1 Level 2 standard.

The bonding of a layer of a knitted or woven textile material to a kitted or woven liquid crystal polymer-based textile material stabilises the liquid crystal polymer-based textile material, and allows the resulting laminated textile material to be cut using conventional cutting techniques with high levels of accuracy. This is highly advantageous, as the laminated textile material has the advantages of the liquid crystal polymer-based textile material and can therefore be used to produce apparel or clothing or the like that satisfies the needs of abrasion resistance, cut resistance, low thermal conductivity and consistent strength life combined with the ability to create textiles that have an acceptable look and feel to the end user. In particular, the manufacture of clothing from a thermotropic liquid crystal polymer-based yarn such as a Vectran® becomes viable when a textile material incorporating thermotropic liquid crystal polymer-based yarn is provided with a layer of woven non-TLCP textile material, as this allows the resulting laminated textile material to be cut with sufficient speed and accuracy for volume manufacturing. Furthermore, the resulting laminated textile material also has improved abrasion and cut resistance, and impact protection.

Embodiments of the laminated textile material described herein have enhanced durability whilst also being light, flexible and drapeable, and therefore much more acceptable to the end user when used in clothing. Therefore, the laminated textile material described herein can be used to produce protective clothing, including protective clothing for motorcyclists. Other applications include clothing for the military for the prevention and minimisation of injuries and clothing for fire-fighters and the like.

It will be appreciated that although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. For example, those skilled in the art will appreciate that the specific examples described above relate to liquid crystal polymer-based textiles that comprise a TLCP fibre; however, the method of bonding the liquid crystal polymer-based textile to a further non-TLCP fibre textile in order to facilitate cutting of the liquid crystal polymer-based textile is equally applicable to other liquid crystal polymer fibres that may also be difficult to cut using conventional textile cutting techniques.

1. A drapable textile material, comprising:
a base layer of a first knitted or woven textile material,
a stabilising layer of a second knitted or woven textile material, and
a bonding agent intermediate of the base layer and the stabilising layer that bonds the base layer to the stabilising layer,
wherein the first knitted or woven textile comprises a liquid crystal polymer fibre and the second knitted or woven textile material consists of fibres that differ from the liquid crystal polymer fibre, wherein the bonding agent bonds a surface of the stabilising layer to an opposing surface of the base layer and only partially penetrates both the stabilising layer and the base layer.

2. (canceled)

3. (canceled)

4. A drapable textile material according to claim 1, wherein the bonding agent only penetrates the stabilising layer so far as to bond with fibres that are present within the surface of the stabilising layer, and only penetrates the base layer so far as to bond with fibres that are present within the opposing surface of the base layer.

5. A drapable textile material according to claim 1, wherein the liquid crystal polymer fibre is a melt-spun liquid crystal polymer fibre.

6. A drapable textile material according to claim 1, wherein the liquid crystal polymer fibre is a thermotropic liquid crystal polymer fibre.

7. A drapable textile material according to claim 6, wherein the second knitted or woven textile material consists of one or more fibres that are not thermotropic liquid crystal polymer fibres.

8. A drapable textile material according to claim 6, wherein the liquid crystal polymer fibre comprises monomer repeat units derived from 4-hydroxybenzoic acid and 6-hydroxy-2-naphthoic acid.

9. A drapable textile material according to claim 5, wherein the liquid crystal polymer fibre comprises a Vectran® fibre or a derivative thereof, preferably wherein the liquid crystal polymer fibre comprises Vectran® HTME 1670/600 T801M fibre or a derivative thereof.

10. (canceled)

11. A drapable textile material according to claim 1, wherein the bonding agent covers at least 50% of a surface of the stabilising layer and an opposing surface of the base layer.

12. A drapable textile material according to claim 1, wherein the bonding agent is a substantially flexible adhesive, preferably wherein the adhesive has a flexural modulus of between 1,450 psi (9.99 MPa) and 580,000 psi (3,998.96 MPa), and preferably between 6,000 to 7,000 psi (41.37 to 48.26 MPa).

13. (canceled)

14. A drapable textile material according to claim 1, wherein the second knitted or woven textile material consists of cotton or polyester or derivative thereof, preferably, wherein the second knitted or woven textile material is a woven fabric consisting of one or more of cotton and polyester.

15. (canceled)

16. A method of manufacturing a drapable textile material, the method comprising:
bonding a base layer of a first knitted or woven textile material to a stabilising layer of a second knitted or woven textile material using a bonding agent that is disposed intermediate of the base layer and the stabilising layer, wherein the first knitted or woven textile comprises a liquid crystal polymer fibre and the second knitted or woven textile material consists of fibres that differ from the liquid crystal polymer fibre,
wherein the bonding of the base layer to the stabilising layer using a bonding agent includes applying the bonding agent so as to bond a surface of the stabilising later to an opposing surface of the base layer, and
wherein the bonding agent is applied so as to only penetrate both the stabilising layer and the base layer.

17. A method according to claim 16, and further comprising constructing the base layer of the first knitted or woven textile material from a liquid crystal polymer fibre-based yarn using a knitting machine.

18. A method according to claim 16, wherein the liquid crystal polymer fibre is at least one of:
a melt-spun liquid crystal polymer fibre;
a thermotropic liquid crystal polymer fibre;
monomer repeat units derived from 4-hydroxybenzoic acid and 6-hydroxy-2-naphthoic acid; and
Vectran® HTME 1670/600 T801M fibre or a derivative thereof.

19. A method according to claim 16, wherein the second knitted or woven textile material consists of one or more fibres that are not thermotropic liquid crystal polymer fibres.

20. (canceled)

21. (canceled)

22. (canceled)

23. (canceled)

24. (canceled)

25. (canceled)

26. A method according to claim 16, wherein the bonding agent is applied so as to only penetrate the stabilising layer so far as to bond with fibres that are present within the surface of the stabilising layer, and so as to only penetrate the base layer so far as to bond with fibres that are present within the opposing surface of the base layer.

27. A method according to claim 16, wherein the bonding agent covers at least 50% of a surface of the stabilising layer and an opposing surface of the base layer.

28. A method according to claim 16, wherein the bonding agent is a substantially flexible adhesive, preferably wherein the adhesive has a flexural modulus of between 1,450 psi (9.99 MPa) and 580,000 psi (3,998.96 MPa), and preferably between 6,000 to 7,000 psi (41.37 to 48.26 MPa).

29. (canceled)

30. A method according to claim 16, wherein the second knitted or woven textile material consists of cotton or polyester or derivative thereof.

31. (canceled)

32. A textile material obtained or obtainable by the method of claim 16.

33. An item of clothing comprising the textile material according to claim 1.
